(19) United States
(12) Patent Application Publication
(10) Pub. No.: US 2007/0201579 A1
(43) Pub. Date: Aug. 30, 2007

(54) Apparatus and method for compensating for signal distortion in a fixed broadband wireless access system

(75) Inventor: Chang-Seok Lee, Cheonan-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/704,181

(22) Filed: Feb. 8, 2007

(30) Foreign Application Priority Data
Feb. 8, 2006 (KR) 10-2006-0012141

(51) Int. Cl. H04L 25/03

(52) U.S. Cl. 375/296

(57) ABSTRACT

An apparatus and method are provided for compensating for signal distortion in a fixed broadband wireless access system. A coefficient extractor determines state information of a data input channel used by a terminal for performing wireless access communication, extracts a compensation coefficient value of a signal according to the channel state information, and outputs the extracted compensation coefficient value. An equalizer compensates for signal distortion according to a channel state with the compensation coefficient value based on the input channel state information input from the coefficient extractor.

### PRIORITY

This application claims priority under 35 U.S.C. §119 to an application entitled “Apparatus and Method for Compensating for Signal Distortion in a Fixed Broadband Wireless Access System” filed in the Korean Intellectual Property Office on Feb. 8, 2006 and assigned Serial No. 2006-12141, the contents of which are incorporated herein by reference.

### BACKGROUND OF THE INVENTION

1. Field of the Invention

The present invention generally relates to an apparatus and method for compensating for signal distortion in a fixed broadband wireless access system, and more particularly to distortion compensation based on channel states when data is transmitted and received in a time division duplex (TDD) mode in a fixed broadband wireless access system.

2. Description of the Related Art

In a time division duplex (TDD) system, the same frequency is shared between uplink and downlink. Using a shared channel, a transmission stage can process various adaptive signals. In particular, because a channel in a fixed broadband wireless access (FBWA) system is not faster than a mobile channel, an uplink channel characteristic is estimated, such that the estimated uplink channel characteristic can be applied to a downlink channel.

In the FBWA system, multipath spreading leads to intersymbol interference. Conventionally, the intersymbol interference can be reduced using an equalizer. FIG. 2 is a block diagram illustrating a signal processing operation in a receiver of a subscriber terminal including a conventional post-equalizer. Referring to FIG. 2, a signal to be input to a receiving terminal is denoted by dk. The signal dk transmitted from a transmitting terminal to the receiving terminal is distorted while passing through a radio channel with an impulse response h(n). When a noise signal Vk is added to the distorted signal while it passes through the channel, a modulated signal X(n) is applied to an equalizer of g(n) for post-equalization. The applied signal X(n) passes through the equalizer. A signal for which distortion has been compensated for is generated. That is, the equalizer increases the magnitude of a signal weakened while passing through the channel and decreases the magnitude of a strengthened signal, thereby implementing a smooth channel characteristic.

The prior art has a problem in that a noise component as well as a signal component is amplified because noise added to an input signal of the receiver is multiplied by a gain value of the equalizer. That is, there is a problem in that a signal to noise ratio (SNR) decreases. The equalizer implemented in a subscriber terminal corresponding to the receiver of a downlink channel increases the complexity of a terminal system and adversely affects the miniaturization of a mobile terminal.

### SUMMARY OF THE INVENTION

It is, therefore, an object of the present invention to provide a method and apparatus for compensating for signal distortion that can improve a signal to noise ratio and reduce the complexity of a subscriber terminal.

In accordance with an aspect of the present invention, there is provided an apparatus for compensating for signal distortion in a fixed broadband wireless access system, that includes a coefficient extractor for determining state information of a data input channel according to access from a terminal for performing wireless access communication, extracting a compensation coefficient value of a signal according to the channel state information, and outputting the extracted compensation coefficient value; and an equalizer for compensating for signal distortion according to a channel state with the compensation coefficient value based on the input channel state information input from the coefficient extractor.

In accordance with another aspect of the present invention, there is provided a method for compensating for signal distortion in a fixed broadband wireless access system, that includes detecting a communication request signal from a wireless terminal; analyzing reception channel state information of data from the wireless terminal; determining distortion state information of the signal from the analyzed information; and compensating for signal distortion according to the distortion state information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a time division duplex (TDD) fixed broadband wireless access system;

FIG. 2 is a block diagram illustrating a conventional post-equalizer;

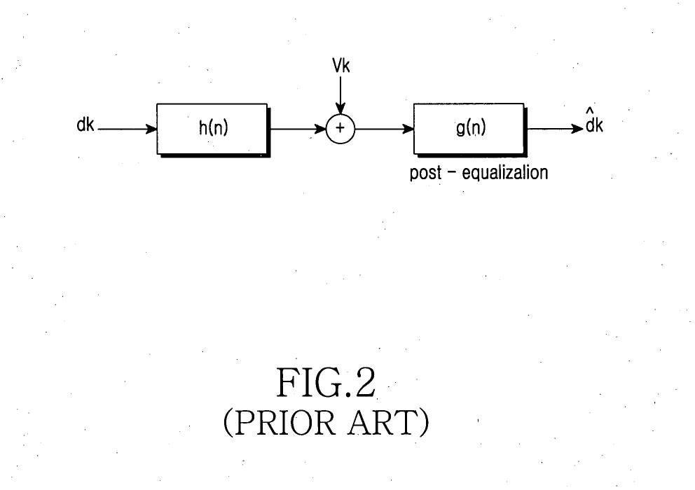

FIG. 3 is a block diagram illustrating a pre-equalization device in accordance with the present invention; and

FIG. 4 is a flowchart illustrating a pre-equalization operation in accordance with the present invention.

### DETAILED DESCRIPTION OF THE PREFERRED EMBODIMENTS

Preferred embodiments of the present invention will be described in detail herein below with reference to the accompanying drawings. In the following description, specific details such as specific components are provided only for a better understanding of the present invention. Those skilled in the art will appreciate that the specific details can be modified or changed without departing from the scope of the present invention.

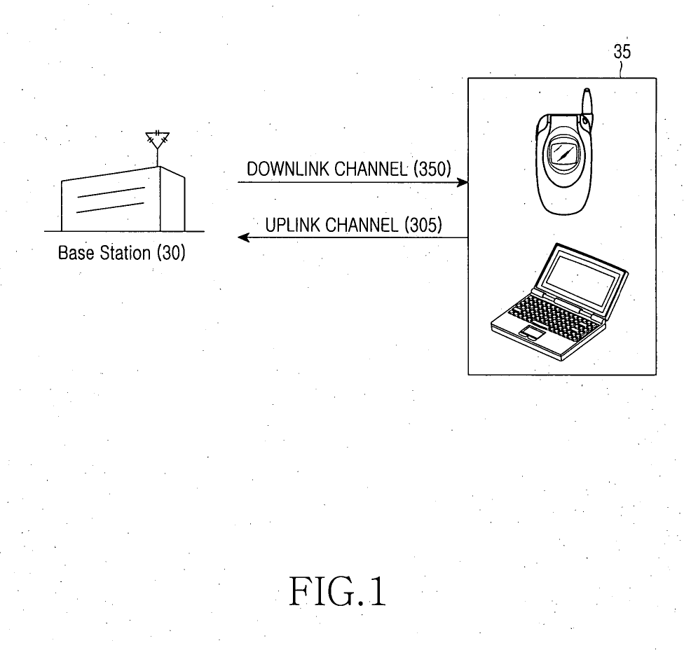

FIG. 1 is a block diagram illustrating a structure of a time division duplex (TDD) fixed broadband wireless access system to which the present invention is applied. Wireless terminals 35 can include a wireless mobile communication terminal or a terminal capable of performing wireless communication such as a notebook computer. Other wireless terminals are contemplated. The terminals connected to a base station 30 fixedly located without mobility perform communication through fixed broadband wireless access (FBWA) for transmitting and receiving wireless communication data. In accordance with the present invention, the terminal 35 does not include an equalizer in a conventional modem chip and therefore an equalization operation is performed in the base station 30 rather than the terminal 35. Thus, the equalizer is provided in the base station 30 rather than the terminal 35. When a wireless system access signal is generated from the terminal 35, the state of a signal input channel (hereinafter, referred to as an uplink channel) is determined from an access signal transmitted from the terminal 35 to the base station 30. The base station 30 can additionally be provided with a channel state analyzer for determining the channel state of the signal received from the terminal 35.

The base station 30 is provided with a coefficient extractor for extracting a compensation coefficient of an equalizer according to the analysis result of the uplink channel state in the channel state analyzer. Thus, a pre-equalization device provided in the base station 30 analyzes the state of the uplink channel received from the wireless terminal and compensates for signal distortion by extracting a distortion compensation coefficient according to analysis result and performing an operation on the coefficient value and a distortion signal. If data of a preset time or predetermined packet unit is input, the uplink channel state is analyzed when data of the previous time period or the last data of a packet is input.

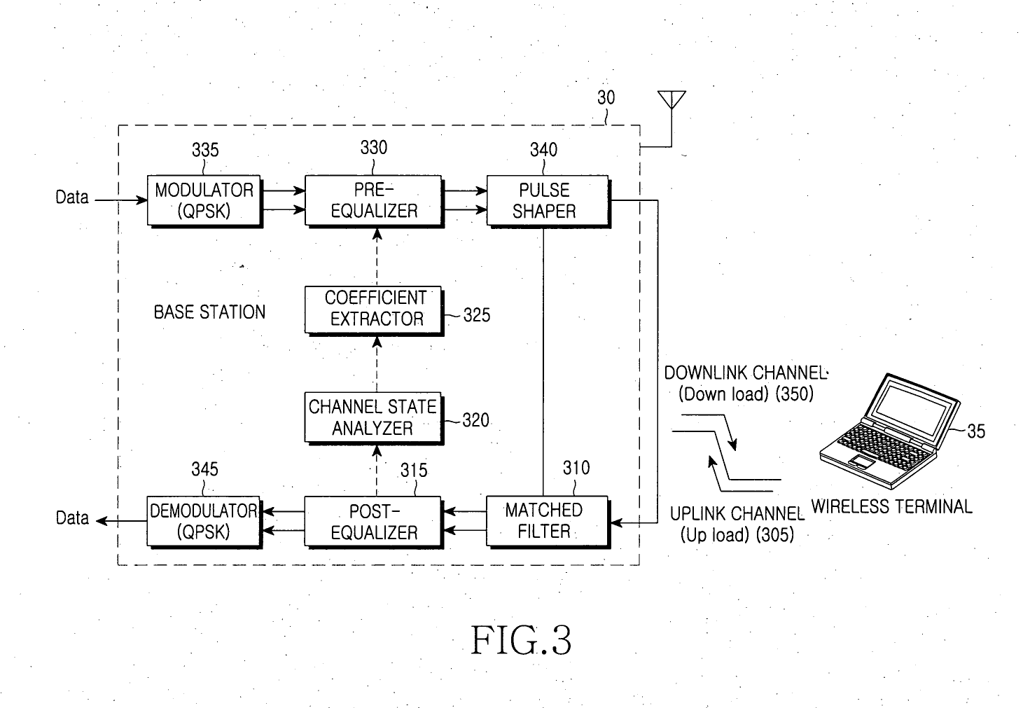

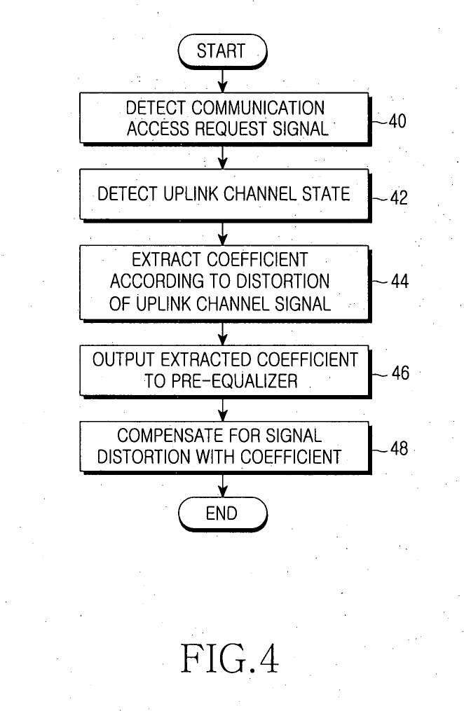

FIG. 3 is a block diagram illustrating the pre-equalization device in the TDD fixed broadband wireless access system in accordance with a the present invention and FIG. 4 is a flowchart illustrating a pre-equalization operation in the TDD fixed broadband wireless access system in accordance with the present invention. Referring to FIGS. 3 and 4, the wireless terminal 35 transmits a signal for a connection with the base station 30 in order to perform wireless communication through various inputs of a user. The base station 30 detects a wireless access signal received from the wireless terminal 35 through an uplink channel in step 40. A matched filter 310 provided in the base station 30 enables only a preset wireless access signal to be input. The matched filter 310 receives a signal in which a distorted signal is added to various noise components while passing through a wireless link.

A demodulator 345 performs a demodulation process for a data signal received from the matched filter 310 through an equalizer 315 and then outputs data. When the signal passes through the equalizer 315, information about the signal is output to a channel state analyzer 320. In order to analyze a state of the uplink channel on which the data is transmitted to the base station 30, the channel state analyzer 320 analyzes the state of the uplink channel from a signal output thereto in step 42. A coefficient extractor 325 in step 44 extracts a compensation coefficient value for compensating an uplink channel signal according to uplink channel state analyzed by the channel state analyzer 320. The coefficient extractor 325 extracts the coefficient value for generating a normal signal by compensating a distorted signal according to noise and distortion levels of the signal carried on the uplink channel. Amplitude and phase distortions of the signal can be equalized with the coefficient value.

When the base station 30 outputs a response signal to a request signal of the wireless terminal 35, a modulator 335 performs a modulation process for input data and a pre-equalizer 330 performs a pre-compensation process for a signal to be output to the wireless terminal 35 using the coefficient value extracted by the coefficient extractor 325. The base station 30 analyzes signal distortion and incoming noise according to uplink channel state and pre-compensates for distortion of the signal to be output to the wireless terminal 35 through a downlink channel, thereby reducing loss of data to be received by the wireless terminal 35.

A process for pre-equalizing a signal to be transmitted on the downlink channel in the pre-equalizer 330 will be described in detail. The coefficient value extracted by the coefficient extractor 325 is output to the pre-equalizer 330 in step 46. The pre-equalizer 330 performs the pre-equalization process to transmit a response signal on the downlink channel using the coefficient value extracted by the coefficient extractor 325 according to signal distortion in response to a request signal from the wireless terminal 35 in step 48. Signal compensation is performed in advance by predicting signal distortion with an associated coefficient value according to incoming noise and distortion of a signal to be input through the uplink channel when the signal is transmitted on the downlink channel. Then, a signal compensated through the distortion prediction is output to a pulse shaper 340. The pulse shaper 340 shapes a pulse of the compensated signal. The response signal is transmitted on the downlink channel in response to the request signal from the wireless terminal 35.

As described above, a configuration and operation in accordance with the present invention can be achieved. Although the present invention has been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

In the present invention, a base station performs a pre-equalization process in a TDD fixed broadband wireless access system, thereby reducing complexity and cost of a terminal and improving a signal to noise ratio.

What is claimed is:

1. An apparatus for compensating for signal distortion in a fixed broadband wireless access system, comprising:
a coefficient extractor for determining state information of a data input channel used by a terminal for performing wireless access communication, extracting a compensation coefficient value of a signal according to the channel state information, and outputting the extracted compensation coefficient value; and
an equalizer for compensating for signal distortion according to a channel state with the compensation coefficient value based on the input channel state information input from the coefficient extractor.

2. The apparatus of claim 1, further comprising:
a channel state analyzer for analyzing the state information of the data input channel.

3. The apparatus of claim 2, wherein the channel state analyzer analyzes state information of a last channel according to an input signal.

4. A method for compensating for signal distortion in a fixed broadband wireless access system, comprising the steps of:
detecting a communication request signal from a wireless terminal;
analyzing reception channel state information of data from the wireless terminal;
determining distortion state information of the signal from the analyzed information; and
compensating for signal distortion according to the distortion state information.

5. The method of claim 4, further comprising:
extracting a compensation coefficient value according to the distortion state information of the signal; and
compensating for the signal distortion by applying the compensation coefficient value to a distortion signal.

6. The method of claim 4, wherein when a state of a received channel is analyzed, a channel state of a last input signal is determined from a signal input during a preset time.
